(19) United States
(12) Patent Application Publication
(10) Pub. No.: US 2025/0071663 A1
(43) Pub. Date: Feb. 27, 2025

(54) METHOD FOR ACCESSING A NETWORK, TERMINAL DEVICE AND NETWORK DEVICE

(71) Applicant: GUANGDONG OPPO MOBILE TELECOMMUNICATIONS CORP., LTD., Dongguan (CN)

(72) Inventors: Haorui YANG, Dongguan (CN); Fei LU, Dongguan (CN); Yang XU, Dongguan (CN)

(21) Appl. No.: 18/948,353

(22) Filed: Nov. 14, 2024

Related U.S. Application Data
(63) Continuation of application No. PCT/CN2022/093679, filed on May 18, 2022.

(51) Int. Cl. H04W 48/08

(52) U.S. Cl. CPC H04W 48/08

(57) ABSTRACT

A first device includes a processor and a memory. The memory is configured to store a computer program, and the processor is configured to call and run the computer program stored in the memory to cause the first device to perform: transmitting first information, where the first information includes information of the first device requesting to access the network and/or information of a group to which the first device belongs; and receiving second information, where the second information includes response information determined according to the first information.

### CROSS-REFERENCE TO RELATED APPLICATION

This application is a Continuation application of International Application No. PCT/CN2022/093679 filed May 18, 2022, which is incorporated herein by reference in its entirety.

### TECHNICAL FIELD

The present application relates to the field of communications, and more particular to a method for accessing a network, a terminal device, and a network device.

### BACKGROUND

The zero-power consumption communication network is a wireless communication technology for short distance and low rate. A zero-power consumption device is capable of converting external energy into electrical energy to support its own operation. In 5G systems, some demands have been emerged which support the zero-power consumption device to access a network. In order to obtain services provided by the network, the zero-power consumption device needs to inform the network of services it needs. Therefore, it is necessary to consider how the zero-power consumption device communicates with the network.

### SUMMARY

An embodiment of the present application provides a method for accessing a network, which includes:
transmitting, by a first device, first information, the first information including information of the first device that requests to access a network and/or information of a group to which the first device belongs; and
receiving, by the first device, second information, the second information including response information that is determined according to the first information.

An embodiment of the present application provides a method for accessing a network, which includes:
receiving, by a second device, first information, the first information including information of a first device that requests to access a network and/or information of a group to which the first device belongs;
obtaining, by the second device, second information, the second information including response information that is determined according to the first information; and
transmitting, by the second device, the second information.

An embodiment of the present application provides a first device, which includes:
a transmitting unit, configured to transmit first information, where the first information includes information of the first device that requests to access a network and/or information of a group to which the first device belongs; and
a receiving unit, configured to receive second information, where the second information includes response information that is determined according to the first information.

An embodiment of the present application provides a second device, which includes:
a receiving unit, configured to receive first information, where the first information includes information of a first device requesting to access a network and/or information of a group to which the first device belongs;
a processing unit, obtain second information, where the second information includes response information determined according to the first information; and
a transmitting unit, configured to transmit the second information.

An embodiment of the present application provides a first device including a processor and a memory. The memory is configured to store a computer program, and the processor is configured to call and run the computer program stored in the memory to cause the first device to perform the above-mentioned method for accessing the network.

An embodiment of the present application provides a second device including a processor and a memory. The memory is configured to store a computer program, and the processor is configured to call and run the computer program stored in the memory to cause the second device to perform the above-mentioned method for accessing the network.

An embodiment of the present application provides a chip, which is configured to implement the above-mentioned method for accessing the network.

Specifically, the chip includes a processor that is configured to call and run a computer program from a memory to cause a device equipped with the chip to perform the above-mentioned method for accessing the network.

An embodiment of the present application provides a non-transitory computer-readable storage medium, which is configured to store a computer program. The computer program, when executed on a device, causes the device to perform the above-mentioned method for accessing the network.

An embodiment of the present application provides a computer program product which includes a computer program instruction. The computer program instruction causes a computer to perform the above-mentioned method for accessing the network.

An embodiment of the present application provides a computer program that, when executed on a computer, causes the computer to execute the above-mentioned method for accessing the network.

An embodiment of the present application provides a communication system, which includes:
a first device, configured to perform the above-mentioned method for accessing the network; and
a second device, configured to perform the above-mentioned method for accessing the network.

### BRIEF DESCRIPTION OF THE DRAWINGS

FIG. 1 is a schematic diagram illustrating an application scenario according to an embodiment of the present application.

FIG. 2 is a schematic diagram of a zero-power consumption communication system.

FIG. 3 is a schematic diagram illustrating an exemplary system architecture of a 5G network.

FIG. 4 is a schematic flowchart of a method for accessing a network according to an embodiment of the present application.

FIG. 5 is a schematic flowchart of a method for accessing a network according to another embodiment of the present application.

FIG. 6 is a schematic block diagram of a first device according to an embodiment of the present application.

FIG. 7 is a schematic block diagram of a second device according to an embodiment of the present application.

FIG. 8 is a flowchart of Example 1 of a method for accessing a network according to an embodiment of the present application.

FIG. 9 is a flowchart of Example 2 of a method for accessing a network according to an embodiment of the present application.

FIG. 10 is a schematic block diagram of a communication device according to an embodiment of the present application.

FIG. 11 is a schematic block diagram of a chip according to an embodiment of the present application.

FIG. 12 is a schematic block diagram of a communication system according to an embodiment of the present application.

### DETAILED DESCRIPTION

Technical solutions in the embodiments of the present application will be described below with reference to the accompanying drawings in the embodiments of the present application.

Technical solutions according to embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), a wireless fidelity WiFi), a 5th-Generation (5G) communication system, and other communication systems.

Generally, traditional communication systems support a limited quantity of connections, and are easy to implement. However, with the development of communication technology, mobile communication systems will not only support traditional communication, but also support, for example, device to device (D2D) communication, machine to machine (M2M) communication, machine type communication (MTC), vehicle to vehicle (V2V) communication, and vehicle to everything (V2X) communication, and the embodiments of the present application may be applied to these communication systems as well.

In an implementation, the communication systems in the embodiments of the present application may be applied to a carrier aggregation (CA) scenario, a dual connectivity (DC) scenario, or a standalone (SA) networking scenario.

In an implementation, the communication systems in the embodiments of the present application may be applied to an unlicensed spectrum, which may also be considered as a shared spectrum. The communication systems in the embodiments of the present application may also be applied to a licensed spectrum, which may also be considered as a unshared spectrum.

Various embodiments of the present application are described in combination with a network device and a terminal device. The terminal device may also be referred to as a user equipment (UE), an access terminal, a subscriber unit, a subscriber station, a mobile station, a mobile console, a remote station, a remote terminal, a mobile device, a user terminal, a terminal, a wireless communication device, a user agent or a user apparatus.

The terminal device may be a station (ST) in the WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next generation communication system, e.g., an NR network, or a terminal device in a future evolved public land mobile network (PLMN) network, etc.

In the embodiments of the present application, the terminal device may be deployed on land including indoor or outdoor, handheld, wearable or vehicle-mounted; alternatively, the terminal device may be deployed on water (such as on ships); alternatively, the terminal device may be deployed aerially (such as in airplanes, balloons and satellites).

In the embodiments of the present application, the terminal device may be a mobile phone, a pad, a computer with wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

As an example rather than a limitation, the terminal device in embodiments of the present application may also be a wearable device. The wearable device may also be referred to as a wearable smart device, which is a general term of wearable devices developed by intelligent design on daily wear by applying wearable technology, such as glasses, gloves, a watch, clothing and shoes. The wearable device is a portable device that is worn directly on a body, or integrated into clothes or accessories of a user. The wearable device is not only a hardware device, but also implements powerful functions through software support as well as data interaction or cloud interaction. Generalized wearable smart devices include devices which are fully functional, have large sizes, and may implement complete or partial functions without relying on smart phones, such as a smart watch or smart glasses, and devices which focus on a certain kind of application functions only and need to be used in conjunction with other devices such as smart phones, such as various smart bracelets, and smart jewelries for monitoring physical signs.

In the embodiments of the present application, the network device may be a device configured to communicate with a mobile device, and may be an access point (AP) in the WLAN, a base transceiver station (BTS) in GSM or CDMA, a NodeB (NB) in WCDMA, an evolutional node B (eNB or eNodeB) in LTE, a relay station, an access point, a vehicle-mounted device, a wearable device, a network device (gNB) in an NR network, a network device in the future evolved PLMN network, or a network device in an NTN network.

As an example rather than a limitation, the network device in an embodiment of present application may have mobile characteristics. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may be a base station disposed in a position on land or in a water region.

In the embodiments of the present application, the network device may provide a service for a cell, and the terminal device communicates with the network device through a transmission resource (e.g., a frequency-domain resource, which is also referred to as a spectrum resource) used by the cell. The cell may be a cell corresponding to the network device (e.g., a base station), and the cell may belong to a macro base station, or may belong to a base station corresponding to a small cell. The small cells herein may include a metro cell, a micro cell, a pico cell, a femto cell, and the like. These small cells are characterized by a small coverage range and a low transmission power, and are suitable for providing high-speed data transmission service.

In the embodiments of the present application, a method for accessing a network is provided, which includes:
transmitting, by a first device, first information, the first information including information of the first device that requests to access a network and/or information of a group to which the first device belongs; and
receiving, by the first device, second information, the second information including response information that is determined according to the first information.

In a possible implementation, the first device is a zero-power consumption terminal.

In a possible implementation, the first information includes at least one of the following:
a group identity (ID) of the first device, an 1D of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In a possible implementation, the response information includes at least one of the following:
information on admission to the network, including information of the first device admitted to the network and/or information of the group to which the first device belongs; or
rejection information, including a reason for rejecting access to the network.

In a possible implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

In a possible implementation, the group ID includes at least one of a globally unique ID, a group ID within a service, or an ID unique in a PLMN.

In a possible implementation, the service ID includes at least one of an application ID or an ID defined by an operator.

In a possible implementation, a device ID is at least one of a radio frequency identifier (RFID) of a device, an ID defined by an operator, or a network access identifier (NAI).

In a possible implementation, a category of a device includes at least one of a zero-power consumption terminal, a group head terminal, or other non-group head terminal in a group.

In a possible implementation, a condition for the first device to transmit the first information includes at least one of the following:
the first device generating a service demand;
the first device having received a trigger signal;
the first device reaching at a preset time point; or
the first device being manually triggered.

In a possible implementation, the trigger signal includes at least one of the following:
scatter signals periodically transmitted by an access network device;
a trigger signal transmitted by a scanning device; or
a function signal transmitted by the scanning device.

In a possible implementation, transmitting, by the first device, the first information includes:
transmitting, by the first device, the first information to a core network device via an access network device.

In a possible implementation, the method further includes:
transmitting, by the first device, a notification of admission to the network to terminal(s) admitted to the network in the group or other terminal(s) in the group in a case of determining that the network is allowed to access according to the information on admission to the network.

In the embodiments of the present application, another method for accessing a network is provided, which includes:
receiving, by a second device, first information, the first information including information of a first device that requests to access a network and/or information of a group to which the first device belongs;
obtaining, by the second device, second information, the second information including response information that is determined according to the first information; and
transmitting, by the second device, the second information.

In a possible implementation, the first device is a zero-power consumption terminal.

In a possible implementation, the first information includes at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In a possible implementation, the response information includes at least one of the following:
information on admission to the network, including information of the first device admitted to the network and/or information of the group to which the first device belongs; or
rejection information, including a reason for rejecting access to the network.

In a possible implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

In a possible implementation, the group ID includes at least one of a globally unique ID, a group ID within a service, or an ID unique in a PLMN.

In a possible implementation, the service ID includes at least one of an application ID or an ID defined by an operator.

In a possible implementation, a device ID includes at least one of an RFID of a device, an ID defined by an operator, or a NAI.

In a possible implementation, a category of a device includes at least one of a zero-power consumption terminal, a group head terminal, or other non-group head terminal in a group.

In a possible implementation, the second device is an access network device; and receiving, by the second device, the first information includes: receiving, by the second device, the first information from the first device.

In a possible implementation, obtaining, by the second device, the second information includes:
transmitting, by the second device, the first information to a core network device; and receiving, by the second device, the second information from the core network device.

In a possible implementation, the method further includes:
saving, by the second device, the second information.

In a possible implementation, transmitting, by the second device, the second information includes:
transmitting, by the second device, the second information to the first device.

In a possible implementation, the second device is a core network device; and receiving, by the second device, the first information includes: receiving, by the second device, the first information of the first device via an access network device.

In a possible implementation, obtaining, by the second device, the second information includes at least one of the following:
determining, by the second device, the second information according to the first information; or
transmitting, by the second device, the first information to an application device; and receiving, by the second device, the second information determined by the application device according to the first information.

In a possible implementation, transmitting, by the second device, the second information includes:
transmitting, by the second device, the second information to the first device via the access network device.

In a possible implementation, the second device is an application device; and receiving, by the second device, the first information includes: receiving, by the second device, the first information of the first device via a core network device and an access network device.

In a possible implementation, obtaining, the second device, the second information includes: determining, by the second device, the second information according to the first information.

In a possible implementation, transmitting, by the second device, the second information includes:
transmitting, by the second device, the second information to the first device via the core network device and the access network device.

In a possible implementation, a way of determining the second information includes at least one of the following:
checking, by the second device, whether a location range of the first device is within a service area corresponding to a received service ID;
checking, by the second device, whether a location range of a member device in the group to which the first device belongs is within a service area corresponding to a received service ID; or
checking, by the second device, whether at least one of a received service ID, a received group ID, a received ID of the first device, a received ID of a group member, or a number of group members received is consistent with known information of the second device.

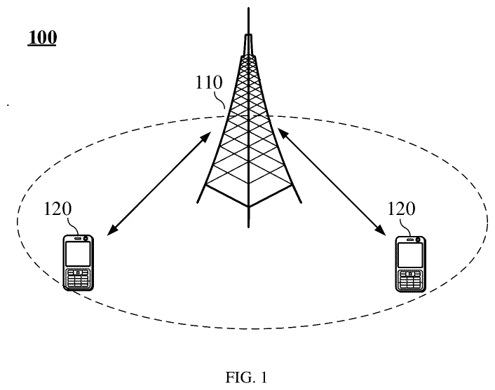

FIG. 1 schematically shows a communication system 100. The communication system includes a network device 110 and two terminal devices 120. In an implementation, the communication system 100 may include a plurality of network devices 110, and each network device 110 may have a coverage area in which other number of terminal devices are included, which is not limited in the embodiments of the present application.

In an implementation, the communication system 100 may further include other network entities such as a mobility management entity (MME), and an access and mobility management function (AMF), which is not limited in the embodiments of the present application.

The network device may include an access network device and a core network device. That is, the wireless communication system further includes a plurality of core networks for communicating with the access network device. The access network device may be an evolutional base station (evolutional node B, which may be abbreviated as eNB or e-NodeB), a macro base station, a micro base station (which may also be referred as a small base station), a pico base station, an access point (AP), a transmission point (TP) or a new generation Node B (gNodeB) in a long-term evolution (LTE) system, a next-generation system (mobile communication system, e.g., next radio (NR) system), or an authorized auxiliary access long-term evolution (LAA-LTE) system.

It should be understood that a device with communication function in a network/system in the embodiments of the present application may be referred to as a communication device. In an example where the communication system is as shown in FIG. 1, the communication device may include a network device with communication function and a terminal device with communication function. The network device and terminal device may be the specific device described in the above embodiments of the present application, which will not be repeated again here. The communication device may further include other device in a communication system, such as a network controller, a mobile management entity, or other network entity, which are not limited in the embodiments of the present application.

It should be understood that the terms “system” and “network” are often used interchangeably herein. The term “and/or” herein refers to an association relationship describing associated objects only, which indicates that there may be three kinds of relationships. For example, “A and/or B” may indicate three cases that: A exists alone, both A and B exist, and B exists alone. In addition, the character “/” herein generally indicates that associated objects before and after the character have an “or” relationship.

It should be understood that “indication” involved in embodiments of the present application may be a direct indication, may be an indirect indication, or may represent an association relationship. As an example, that A indicates B may mean that A indicates B directly, for example, B can be obtained through A; or it may mean that A indicates B indirectly, for example, A indicates C, and B can be obtained through C; or it may mean that there is an association between A and B.

In the description of the embodiments of the present application, the term “correspond” may mean that there is a directly corresponding or an indirectly corresponding relationship between two parties, or mean that there is an association between two parties, or mean a relationship such as indicating and being indicated, or configuring and being configured.

In order to facilitate the understanding of the technical solutions of the embodiments of the present application, related technologies involved in the embodiments of the present application will be described in the following. The following relevant technologies, as optional solutions, can be arbitrarily combined with the technical solutions of the embodiments of the present application, and these combined solutions all fall within the protection scope of the embodiments of the present application.

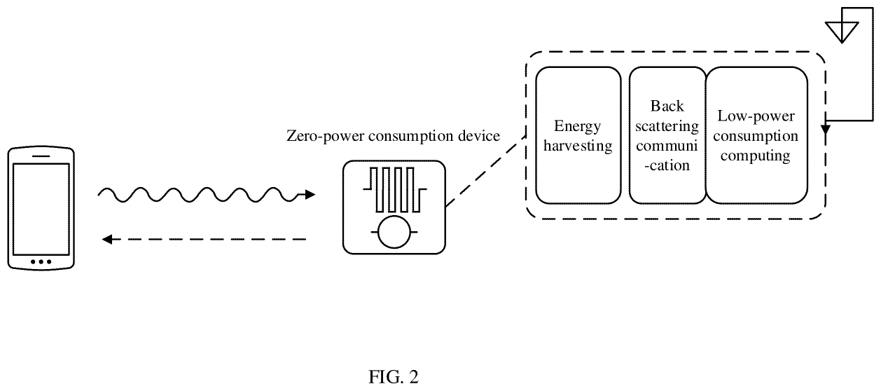

As shown in FIG. 2, a zero-power consumption device mainly combines RF energy harvesting technology, backscattering technology, low-power consumption computing technology. to achieve the advantage that the device node does not need to be equipped with a power supply. The energy collection of zero-power consumption device may also be referred to as RF energy harvesting, which mainly aims to convert RF energy into a direct current. Energy may be stored in a battery or a capacitor, or may be directly used to drive a logic circuit, digital chip or sensor device after being collected, so as to implement functions and applications such as modulation and transmission of a backscatter signal, and collection and processing of sensor information.

With the development of the 5G system, a demand that the 5G system should support a zero-power consumption terminal to access a network has been proposed in the 3GPP standard, which is mainly focused on scenarios with the following characteristics: extreme environment unsuitable for an operation of a general terminal; involving terminals with very low-power consumption and cost; a battery-free terminal. For example, a zero-power consumption communication system may be used in scenarios such as wireless industrial sensing networks, smart agriculture, smart warehousing and logistics, and smart home.

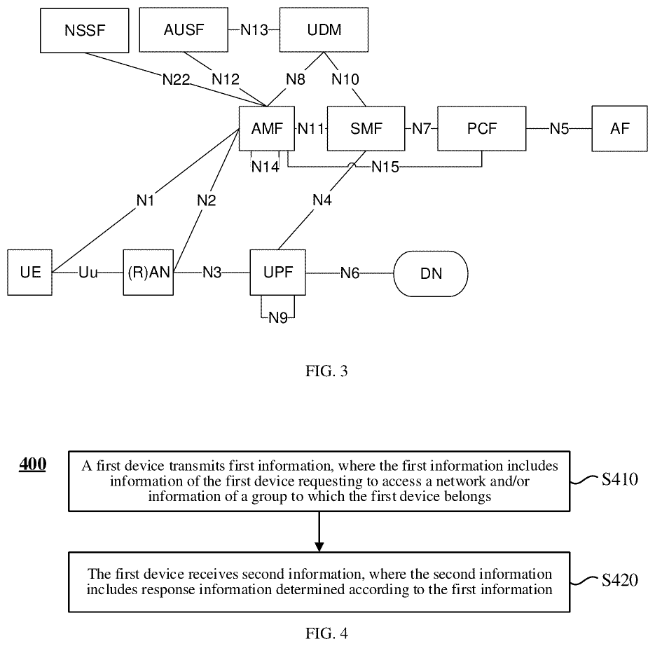

FIG. 3 schematically shows a system architecture of a 5G network. AUE performs access stratum connection, exchanges access layer messages, and performs wireless data transmission with an access network (AN) via a Uu radio interface. The UE performs non-access stratum connection and exchange NAS messages with the access and mobility management function (AMF) via a N1 interface. AMF is responsible for an access and mobility management network element in a core network, and the session management function (SMF) is responsible for a session management network element in the core network. In addition to mobility management for the UE, AMF is also responsible for forwarding session management related messages between the UE and the SMF. The policy control function (PCF) is a policy management function in the core network, and is responsible for formulating policies related to mobility management, session management, and charging of the UE. The user plane function (UPF) is a user plane function in the core network, and implements data transmission with an external data network via a N6 interface and data transmission with AN (or RAN) via a N3 interface. After the UE accesses a 5G network via the Uu interface, the UE transmits service data through the network. When a service is initiated, a network layer of the UE obtains QoS requirements of the service from an upper layer (such as the operating system or application). The UE converts the QoS requirements of the service into QoS parameters for the Uu interface, and transmits data through a corresponding QoS flow between the UE and the UPF under the control of the SMF.

Depending on power source and usage of zero-power-consumption terminals, the zero-power-consumption terminals may be categorized into the following types.

### 1. Passive Zero-Power Consumption Terminal

Zero-power consumption terminals do not need built-in batteries. When a zero-power consumption terminal approaches a network device (e.g., a reader in a radio frequency identification (RFID) system), the zero-power consumption terminal is located within a near-field formed by radiation of antennas of the network device. As such, antennas of the zero-power consumption terminal generates an induced current through electromagnetic induction, and the induced current drives a low-power consumption chip circuit of the zero-power consumption terminal, thereby implementing operations such as demodulating a forward link signal, and modulating a reverse link signal. For a backscatter link, the zero-power consumption terminal uses a way of backscatter to transmit signals.

It can be seen that the passive zero-power consumption terminal does not need a built-in battery to drive either a forward link or a reverse link, and is a true zero-power consumption terminal.

The passive zero-power consumption terminal does not need batteries, and the radio frequency circuit and baseband circuit are very simple. For example, the passive zero-power consumption terminal does not need devices such as a low-noise amplifier (LNA), a power amplifier (PA), a crystal oscillator, and an analog-to-digital converter (ADC), and thus has many advantages such as small size, light weight, very low price, and a long service life.

This type of terminal device may further have the following characters: 1) no battery; 2) obtaining energy from the ambient environment (such as radio waves, solar energy, wind energy, or mechanical kinetic energy); 3) no USIM card. This type of terminal device may further store a certain amount of energy through the ambient environment, but the energy is generally limited, so the supported functional logic is much less than that of general mobile phone terminal.

### 2. Semi-Passive Zero-Power Consumption Terminal

The semi-passive zero-power consumption terminal does not have a conventional battery installed in the terminal, but can use an RF energy harvesting module to harvest radio wave energy and store the harvested energy in an energy storage unit (e.g., a capacitor). After the energy storage unit obtains energy, the energy may drive a low-power consumption chip circuit of the zero-power consumption terminal, thereby implementing operations such as demodulating a forward link signal and modulating a reverse link signal. For a backscatter link, the zero-power consumption terminal uses a way of backscatter to transmit signals.

It can be seen that the semi-passive zero-power consumption terminal does not need a built-in battery to drive either the forward link or the reverse link. The energy stored in the capacitor will be used in operation, but the energy comes from radio energy collected by the energy harvesting module. Therefore, the semi-passive zero-power consumption terminal is also a true zero-power consumption terminal.

The semi-passive zero-power consumption terminal inherits many advantages of the passive zero-power consumption terminal, so the semi-passive zero-power consumption terminal has many advantages such as a small size, a light weight, a very low price and a long service life.

### 3. Active Zero-Power Consumption Terminal

The zero-power consumption terminal used in some scenarios may also be an active zero-power consumption terminal, and such type of terminals may have built-in batteries. The batteries are used to drive a low-power chip circuit of the zero-power consumption terminal, thereby implementing operations such as demodulating a forward link signal and modulating a reverse link signal. However, for a backscatter link, the zero-power consumption terminal uses a way of backscatter to transmit signals. Therefore, the zero power consumption of such type of terminal is mainly embodied in that signal transmission of the reverse link does not consume the terminals' own power, but uses the way of backscatter.

The active zero-power consumption terminal is equipped with a built-in battery to supply power to a RFID chip, increase the reading and writing distance of the tag, and improve the reliability of communication. Therefore, the active zero-power consumption terminal can be applied in some scenarios with relatively high requirements on communication distance or reading latency.

Since the zero-power consumption terminal, such as the passive zero-power consumption terminal, is characterized by very low complexity, the zero-power consumption terminal may not be able to support a complex protocol stack and a complex communication process. However, in order to obtain network services, the zero-power consumption terminal needs to let the network know that it needs services. In order to adapt to the characteristics of the zero-power consumption terminal, such as the passive zero-power consumption terminal, how to initiate communication with the network needs to be solved.

FIG. 4 is a schematic flowchart of a method 400 for accessing a network according to an embodiment of the present application. Optionally, the method may be applied to the system shown in FIG. 1, but is not limited thereto. The method includes at least part of the following content.

In S410, a first device transmits first information, where the first information includes information of the first device requesting to access a network and/or information of a group to which the first device belongs.

In S420, the first device receives second information, where the second information includes response information determined according to the first information.

In an implementation, the first device is a zero-power consumption terminal, such as the above-mentioned passive zero-power consumption terminal, semi-passive zero-power consumption terminal, or active zero-power consumption terminal.

For example, the zero-power consumption terminal may transmit the first information to a network device, and the first information includes information of the zero-power consumption terminal.

In another example, a plurality of zero-power consumption terminals form a group, and the group includes a plurality of member devices including: terminal A, terminal B and terminal C, in which terminal A is the group head terminal. Terminal A may transmit first information to a network device, and the first information includes information of the terminal A and information of the group to which the terminal A belongs.

In an implementation, the first information includes at least one of the following: a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In the embodiments of the present application, the information of the first device may include at least one of a service ID requested by the first device, the ID of the first device, the category of the first device, or the like. The information of the group to which the first device belongs may include at least one of the group ID of the first device, ID(s) of member device(s) in the group to which the first device belongs, the number of member device(s) in the group to which the first device belongs, location range(s) of member device(s) in the group to which the first device belongs, category(ies) of member device(s) in the group to which the first device belongs, the service ID requested by the first device, or the like.

For example, the first information transmitted by a zero-power consumption terminal to a network device includes an ID, category, and service ID requested by the zero-power consumption terminal. In another example, a group includes a plurality of member devices including: terminal A, terminal B, and terminal C, in which terminal A is the group head terminal. The first information transmitted by the group head terminal A to the network includes the group identity (ID), IDs of terminal A, terminal B and terminal C in the group, the number of member devices in the group, i.e., “3”, location ranges of terminal A, terminal B and terminal C in the group, the service ID requested to be used, and the categories of terminal A, terminal B and terminal C in the group.

In the embodiments of the present application, the IDs of other member devices in the group may be pre-configured in the group head terminal, or the IDs of other member devices in the group may be obtained through a certain communication. The first devices, such as zero-power consumption terminals, may be grouped according to services, and the zero-power consumption terminals included in groups corresponding to different services may be different. Accordingly, service IDs may have a correspondence with group IDs. Service IDs and/or group IDs may have a correspondence with IDs of member device in the group.

In an implementation, the response information includes at least one of the following:
information on admission to the network, including information of the first device admitted to the network and/or information of the group to which the first device belongs; or
rejection information, including a reason for rejecting access to the network.

In the embodiments of the present application, if the network device allows some or all devices requesting to access the network to access the network, the network device may transmit response information including information on admission to the network to the first device. If the network device considers that all devices requesting to access the network are not admitted to the network, the network device transmits rejection information to the first device. The rejection information may include a reason for rejecting access to the network and may further include information of device(s) rejected to access the network.

In an implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

For example, if devices requesting to access a network indicated by the first information include terminal A, terminal B, and terminal C, and the network device determines that the devices allowed to access the network include terminal A and terminal B, the response information transmitted by the network device to the first device may include: a service ID allowed for use, a service area corresponding to the service ID allowed for use, an admitted group ID, an ID of the admitted terminal A, an ID of the admitted terminal B in the group and the number of admitted member devices in the group, i.e., “2”.

In an implementation, the above-mentioned group ID includes at least one of a globally unique ID, a group ID within a service, or an ID in unique a PLMN.

In an implementation, the above-mentioned service ID includes at least one of an application ID or an ID defined by an operator.

In an implementation, the above-mentioned device ID is at least one of a radio frequency identifier (RFID) of the device, an ID defined by an operator, and a network access identifier (NAI).

In an implementation, the category of a device includes at least one of a zero-power consumption terminal, a group head terminal, or other non-group head terminal in the group. In the embodiments of the present application, certain identifiers may be used to indicate the category of a device. For example, 0 denotes a zero-power consumption terminal, 1 denotes a group head terminal, and 2 denotes other non-group head terminal in the group. In another example, S1 denotes a passive zero-power consumption terminal, S2 denotes a semi-passive zero-power consumption terminal, and S3 denotes an active zero-power consumption terminal. In yet another example, G denotes a group head terminal, and P denotes other non-group head terminal in the group.

In an implementation, the condition for the first device to transmit the first information includes at least one of the following:
the first device generating a service demand;
the first device having received a trigger signal;
the first device reaching at a preset time point; or
the first device being manually triggered.

In the embodiments of the present application, the service demand may include start of a service within a terminal or a requirement of data transmission. For example, a zero-power consumption terminal for collecting temperature needs to report the collected temperature information.

In the embodiments of the present application, the trigger signal may include a signal with energy transmitted by other devices outside the first device.

In the embodiments of the present application, a time point for triggering access to the network may be preset, and when the current time reaches the time point, the first device is triggered to transmit the first information. Preset time points set on different devices may be different. The preset time points corresponding to different services may be different.

In an implementation, the trigger signal includes at least one of the following:
scatter signals periodically transmitted by an access network device;
a trigger signal transmitted by a scanning device; or
a function signal transmitted by the scanning device.

For example, if the first device detects scatter signals periodically transmitted by a nearby base station, the energy of the scatter signals may be converted into current to trigger the first device to transmit the first information. For example, the first device may be triggered to transmit the first information to the base station that transmits the scatter signals, or the first device may be triggered to transmit the first information to other base stations.

In an implementation, transmitting, by the first device, the first information includes:
transmitting, by the first device, the first information to a core network device via an access network device.

For example, the first device transmits an AS message to an access network device, and the AS message carries the first information. After the access network device obtains the first information by parsing the AS message, the access network device re-encapsulates the first information into a NAS message, and then transmits the NAS message carrying the first information to a core network device.

In another example, the first device transmits a NAS message to an access network device, and the NAS message carries the first information. The access network device transparently transmits the NAS message to a core network device. In this case, it may also be considered that the first device transmits the first information to the core network device.

In a possible implementation, the method further includes:
in a case that the first device determines that the network is allowed to access according to the information on admission to the network, transmitting, by the first device, a notification of admission to the network to terminal(s) admitted to the network in the group or other terminal(s) in the group.

For example, if it is determined according to the information on admission to the network that all the terminals in the entire group are allowed to access the network, the group head terminal A transmits a notification to the other member devices in the group, i.e., terminal B and terminal C, to notify terminal B and terminal C that it is allowed to access the network.

In another example, if it is determined according to the information on admission to the network that a portion of terminals, such as terminal B, are allowed to access the network, a notification may be transmitted to terminal B admitted to the network, to notify terminal B that it is allowed to access the network.

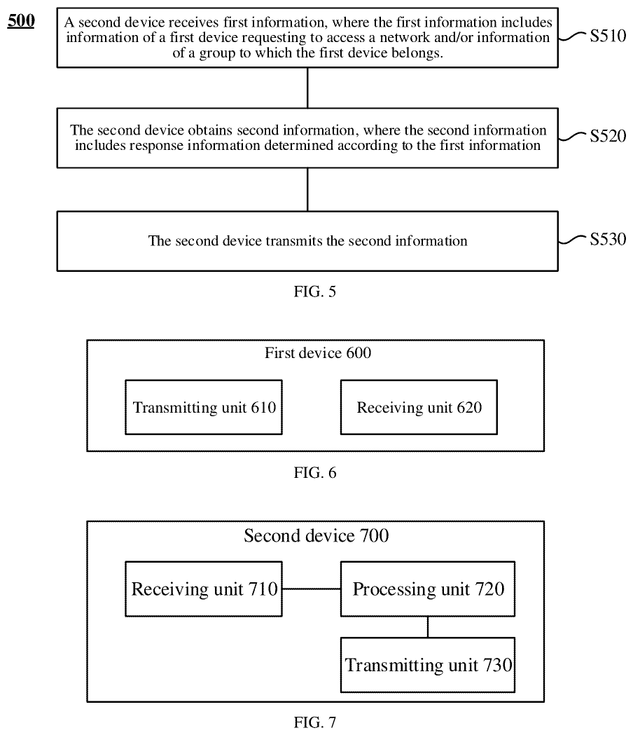

FIG. 5 is a schematic flowchart of a method 500 for accessing a network according to an embodiment of the present application. Optionally, the method may be applied to the system shown in FIG. 1, but is not limited thereto. The method includes at least part of the following content.

In S510, a second device receives first information, where the first information includes information of a first device requesting to access a network and/or information of a group to which the first device belongs.

In S520, the second device obtains second information, where the second information includes response information determined according to the first information.

In S530, the second device transmits the second information.

In an implementation, the first device is a zero-power consumption terminal.

In an implementation, the first information includes at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In an implementation, the response information includes at least one of the following:
information on admission to the network, including information of the first device admitted to the network and/or information of the group to which the first device belongs; or
rejection information, including a reason for rejecting access to the network.

In an implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

In an implementation, the group ID includes at least one of a globally unique ID, a group ID within a service, or an ID unique in a PLMN.

In an implementation, the service ID includes at least one of an application ID or an ID defined by an operator.

In an implementation, the device ID includes at least one of an RFID of the device, an ID defined by an operator, or a NAI.

In an implementation, the category of a device includes at least one of a zero-power consumption terminal, a group head terminal, or other non-group head terminal in a group.

In an implementation, the second device is an access network device. Receiving, by the second device, the first information includes: receiving, by the second device, the first information from the first device.

In an implementation, if the second device is an access network device, obtaining, by the second device, the second information includes:
transmitting, by the second device, the first information to a core network device; and receiving, by the second device, the second information from the core network device.

In an implementation, if the second device is an access network device, the method further includes: saving, by the second device, the second information.

In an implementation, if the second device is an access network device, transmitting, by the second device, the second information includes: transmitting, by the second device, the second information to the first device.

In the embodiments of the present application, a zero-power consumption terminal may transmit first information to a second device, such as an access network device. After receiving the first information, the second device may transmit the first information to a core network device. The core network device may determine, according to information it has known, that the first device and/or member device(s) in the group to which the first device belongs expect to access the network. The core network device may further transmit the first information to a service-related application device, and the application device determines whether the first device and/or member device(s) in the group to which the first device belongs are allowed to access the network. The application device then transmits information to the core network device regarding whether the first device and/or the member device in the group to which the first device belongs are allowed to access the network. The core network device may transmit response information to the access network device.

In an implementation, the second device is a core network device, and receiving, by the second device, the first information includes: receiving, by the second device, the first information from the first device via an access network device.

In the embodiments of the present application, the second device, such as an access network device, may transmit response information to the zero-power consumption terminal. For example, the access network device may transparently transmit a NAS message including response information to the zero-power consumption terminal, or may parse and re-encapsulate the NAS message and then transmit an AS message including response information to the zero-power consumption terminal.

In an implementation, if the second device is a core network device, obtaining, by the second device, the second information includes at least one of the following:
determining, by the second device, the second information according to the first information; or
transmitting, by the second device, the first information to an application device; and receiving, by the second device, the second information determined by the application device according to the first information.

In the embodiments of the present application, the zero-power consumption terminal may transmit first information to an access network device. After receiving the first information, the access network device may transmit the first information to a second device, such as a core network device. The second device receives the first information via the access network device and may determine, according to information it has known, that the first device and/or member device(s) in the group to which the first device belongs, that the first device expects to access to the network. The second device may further transmit the first information to a service-related application device, and the application device determines whether the first device and/or member device(s) in the group to which the first device belongs are allowed to access the network. The application device then transmits information to the core network device regarding whether the first device and/or the member device in the group to which the first device belongs are allowed to access the network.

In an implementation, if the second device is a core network device, transmitting, by the second device, the second information includes: transmitting, by the second device, the second information to the first device via an access network device.

In the embodiments of the present application, the second device, such as a core network device, may transmit response information to an access network device, and the access network device then transmits the response information to the zero-power consumption terminal.

In an implementation, the second device is an application device, and receiving, by the second device, the first information includes: receiving, by the second device, the first information from the first device via a core network device and an access network device.

In an implementation, if the second device is an application device, obtaining, by the second device the second information includes: determining, by the second device, the second information according to the first information.

In the embodiments of the present application, the zero-power consumption terminal may transmit first information to an access network device. After receiving the first information, the access network device may transmit the first information to a second device, such as a core network device. The core network device receives the first information via the access network device and may transmit the first information to a service-related second device, such as an application device, and the application device determines whether the first device and/or member device(s) in the group to which the first device belongs are allowed to access the network.

In an implementation, if the second device is an application device, transmitting, by the second device, the second information includes: transmitting, by the second device, the second information to the first device via a core network device and an access network device.

In the embodiments of the present application, the second device, such as an application device, may transmit information on whether the first device and/or member device(s) in the group to which the first device belongs are allowed to access the network to a core network device. The core network device may transmit response information to the access network device, and the access network device then forwards the response information to the zero-power consumption terminal.

In an implementation, a way of determining the second information includes at least one of the following:
checking, by the second device, whether a location range of the first device is within a service area corresponding to a received service ID;
checking, by the second device, whether a location range of a member device in the group to which the first device belongs is within a service area corresponding to a received service ID; or
checking, by the second device, whether at least one of a received service ID, a received group ID, a received ID of the first device, a received ID of a group member, or a number of group members received is consistent with known information of the second device.

For example, the first information received by the core network device or application device includes an ID of the first device, a location range of a zero-power device, and a service ID.

The corresponding service area may be obtained according to the service ID, and may be compared with the location range of the first device to determine whether the location range of the first device is within the service area corresponding to the service ID. If so, the first device is allowed to access the network.

In another example, the first information received by the core network device or application device includes ID(s) and location range(s) of member device(s) in the group to which the first device belongs and a service ID. The corresponding service area may be obtained according to the service ID, and may be compared with the location range(s) of member device(s) in the group to which the first device belongs to determine whether the location range(s) of the member device(s) are within the service area corresponding to the service ID. If so, the member device(s) in the group are allowed to access the network. The location range of each member device in the group may be used for comparison to determine whether the location range of each member device in the group is within the service area corresponding to the service ID. If the location ranges of only some member devices is within the service area corresponding to the service ID, these member devices may be allowed to access the network.

In yet another example, the first information received by the core network device or the application device includes a service ID and IDs of group members. If the application device is capable of searching for the service ID in known information and capable of searching for the group ID corresponding to the service ID, the IDs of the group members may be obtained according to the group ID. If the received service ID and IDs of the group members are consistent with the service ID and IDs of group members found in the known information, the devices corresponding to the IDs of the group members are allowed to access the network.

For specific examples of describing the second device performing the method 500 in the embodiments, reference may be made to the related description about the second device in the above method 400, which will not be repeated here for brevity.

FIG. 6 is a schematic block diagram of a first device 600 according to an embodiment of the present application. The first device 600 may include:
a transmitting unit 610 configured to transmit first information, where the first information includes information of the first device requesting to access the network and/or information of a group to which the first device belongs; and
a receiving unit 620 configured to receive second information, where the second information includes response information determined according to the first information.

In an implementation, the first device is a zero-power consumption terminal.

In an implementation, the first information includes at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In an implementation, the response information includes at least one of the following:
information on admission to the network that includes information of the first device admitted to the network and/or information of the group to which the first device belongs; or rejection information that includes a reason for rejecting access to the network.

In an implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

In an implementation, the group ID includes at least one of a globally unique ID, a group ID within a service, or an ID unique in a PLMN.

In an implementation, the service ID includes at least one of an application ID or an ID defined by an operator.

In an implementation, the device ID is at least one of a radio frequency identifier (RFID) of a device, an ID defined by an operator, or a network access identifier (NAI).

In an implementation, a category of a device includes at least one of a zero-power consumption terminal, a group head terminal, or other non-group head terminal in a group.

In an implementation, a condition for the first device to transmit the first information includes at least one of the following:
the first device generating a service demand;
the first device having received a trigger signal;
the first device reaching at a preset time point; or
the first device being manually triggered.

In an implementation, the trigger signal includes at least one of the following: scatter signals periodically transmitted by an access network device;
a trigger signal transmitted by a scanning device; or
a function signal transmitted by the scanning device.

In an implementation, the transmitting unit 610 is configured to transmit the first information to a core network device via an access network device.

In an implementation, the transmitting unit is further configured to transmit a notification of admission to the network to terminal(s) admitted to the network in the group or other terminal(s) in the group in a case of determining that the network is allowed to access according to the information on admission to the network.

The first device 600 in the embodiments of the present application is capable of implementing the corresponding functions of the first device in the aforementioned method embodiments. The processes, functions, implementations and beneficial effects corresponding to each module (sub-module, unit, or component.) of the first device 600 may be referred to the corresponding description in the aforementioned method embodiments, and will not be repeated here. It should be noted that the functions depicted by the various modules (sub-modules, units or components) of the first device 600 in the embodiments of the present application may be implemented by different modules (sub-modules, units or components) or by the same module (sub-module, unit or component).

FIG. 7 is a schematic block diagram of a second device 700 according to an embodiment of the present application. The second device 700 may include:
a receiving unit configured to receive first information, where the first information includes information of a first device requesting to access a network and/or information of a group to which the first device belongs;
a processing unit 720 configured to obtain second information, where the second information includes response information determined according to the first information; and
a transmitting unit 730 configured to transmit the second information.

In an implementation, the first device is a zero-power consumption terminal.

In an implementation, the first information includes at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

In an implementation, the response information includes at least one of the following:
information on admission to the network that includes information of the first device admitted to the network and/or information of the group to which the first device belongs; or rejection information that includes a reason for rejecting access to the network.

In an implementation, the information on admission to the network includes at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

In an implementation, the group ID includes at least one of a globally unique ID, a group ID within a service, or an ID unique in a PLMN.

In an implementation, the service ID includes at least one of an application ID or an ID defined by an operator.

In an implementation, the device ID includes at least one of an RFID of a device, an ID defined by an operator, or a NAI.

In an implementation, a category of a device includes at least one of a zero-power consumption terminal, a group head terminal, or other non-group head terminal in a group.

In an implementation, the second device is an access network device, and the receiving unit 710 is configured to receive the first information from the first device.

In an implementation, the processing unit 720 is configured to control the transmitting unit 730 to transmit the first information to a core network device, and control the receiving unit 710 to receive the second information from the core network device.

In a possible implementation, if the second device is an access network device, the processing unit 720 is further configured for the second device to save the second information.

In an implementation, if the second device is an access network device, the transmitting unit 730 is configured to transmit the second information to the first device.

In an implementation, the second device is a core network device, and the receiving unit 710 receives the first information of the first device via an access network device.

In an implementation, if the second device is a core network device, the processing unit 720 is configured to perform at least one of the following:
determining the second information according to the first information; or
controlling the transmitting unit 730 to transmit the first information to an application device, and controlling the receiving unit 710 to receive the second information determined by the application device according to the first information.

In an implementation, if the second device is a core network device, the transmitting unit 730 is configured to transmit the second information to the first device via an access network device.

In an implementation, the second device is an application device, and the receiving unit 710 is configured to receive the first information of the first device via a core network device and an access network device.

In an implementation, if the second device is an application device, the processing unit 720 is configured to determine the second information according to the first information.

In an implementation, if the second device is an application device, the transmitting unit 730 is configured to transmit the second information to the first device via a core network device and an access network device.

In an implementation, a way for the processing unit 720 to determine the second information includes at least one of the following:
checking whether a location range of the first device is within a service area corresponding to a received service ID;
checking whether a location range of a member device in the group to which the first device belongs is within a service area corresponding to the received service ID; or
checking whether at least one of a received service ID, a received group ID, a received ID of the first device, a received ID of a group member, or a number of group members received is consistent with known information of the second device.

The second device 700 in the embodiments of the present application is capable of implementing the corresponding functions of the second device in the aforementioned method embodiments. The processes, functions, implementations and beneficial effects corresponding to each module (sub-module, unit, or component.) of the second device 700 may be referred to the corresponding description in the aforementioned method embodiments, and will not be repeated here. It should be noted that the functions depicted by the various modules (sub-modules, units or components) of the second device 700 in the embodiments of the present application may be implemented by different modules (sub-modules, units or components) or by the same module (sub-module, unit or component).

### Example 1

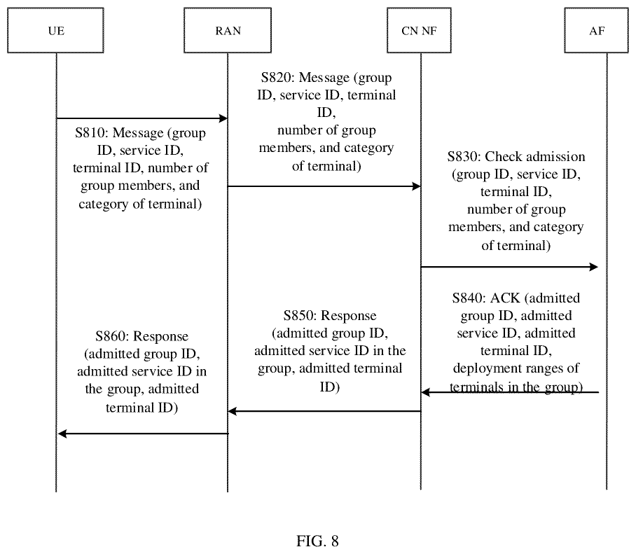

In each service, zero-power consumption terminals may be divided into one or more groups. In each group, a terminal may be selected to request to access the network, such as for network registration, for the other terminals in the group. The registration is not limited to the registration procedure in a 3GPP procedure, but may also represent that the terminal notifies the network that it needs to access the network to obtain services. The identity of the terminal may be preconfigured in the terminal. Alternatively, each terminal may perform registration by itself. As shown in FIG. 8, a procedure of accessing the network may include the following steps.

In S810, when the terminal needs to access the network, the terminal transmits a message to the base station. The message may be an AS message. Scenarios that require network access include at least one of the following:
1. in a case that a service demand is generated within the terminal;
2. in a case that the terminal has received a trigger signal which may come from at least one of the following:
a. periodic transmission by the base station; For example, the terminal transmits a message to the base station by using a scatter signal.
b. a scanning device passed by; For example, the scanning device transmits a trigger signal to the terminal, or supplies power.
c. a time point preset by the terminal;
d. being triggered manually.

The message transmitted by the terminal to the base station may include at least one of the following information: a service ID, a group ID, a terminal ID (UE ID), ID(s) of group member(s), a number of group members (group member number), a category of the terminal (UE category), or a deployment range (location range) of a terminal in the group. All IDs here may be IDs newly defined and dedicated to zero-power communication. In addition, the service ID may be an application ID or an ID defined by an operator. The group ID may be a globally unique ID, a group ID within a service, or an ID unique in a PLMN. The terminal ID may be an RFID or an ID defined by the operator. The category of the terminal may be a category of zero-power consumption terminal, a category of group head terminal, or a category of other terminal in the group, e.g., denoted as Category 1, Category 2, Category 3, respectively.

In S820, the base station forwards the received information to the core network element. For example, after the base station obtains the above information by parsing the AS message, the base station may encapsulate it into a NAS message and transmit it to the core network element.

In S830, the core network element may forward the received information to an external application network element, and may further transmit location information of the terminal to the application network element, and the external application network element may check the received information. The location information of the terminal may be reported by the base station to the core network element, or may be obtained by the core network element itself through other means. In addition, the core network element may obtain the information to be checked from the application network element in advance, and the core network element checks the information received from the base station.

The application network element checks whether the location of the terminal is within the service area corresponding to the received service ID, and may further check whether the deployment ranges (location ranges) of the terminals in the group is within the service area corresponding to the received service ID, for example, may check whether the group ID, terminal ID, IDs and number of group members are consistent with the IDs and number of group members corresponding to the received service ID and/or group ID.

In S840, the application network element returns an admitted service ID and the corresponding service area, an admitted group ID, an admitted terminal ID (UE ID), and IDs and numbers of group members. For example, the application network element transmits an acknowledgment (ACK) message to the core network element, which includes an admitted group ID, an admitted terminal ID, an admitted service ID, and a corresponding service area.

In S850, the core network element considers that the received group ID, terminal ID, and group members are allowed to access and that they have been registered in the network, and service transmissions may be performed for these terminals in the group. It may be possible that the core network element only allows some terminals in the group to access according to the current load situation.

The core network element notifies the base station of admission information. For example, the core network element transmits a response message to the base station, which may include at least one of an admitted service ID and a corresponding service area, an admitted group ID, an admitted terminal ID, ID(s) of admitted group member(s) (admitted UE IDs in the group), or the number of admitted group member(s).

In S860, the base station saves the admission information and forwards the admission information to the terminal.

After receiving the admission information, the terminal may determine whether the network is allowed to access according to the admission information, and notify the group members allowed by an application, or notify other terminals in the group via a PC5 interface.

In this example, group registration used may reduce overall signaling exchanges and reduce complexity.

### Example 2

The main difference between this example and Example 1 is that the terminal transmits a NAS message to the core network element for registration in this example.

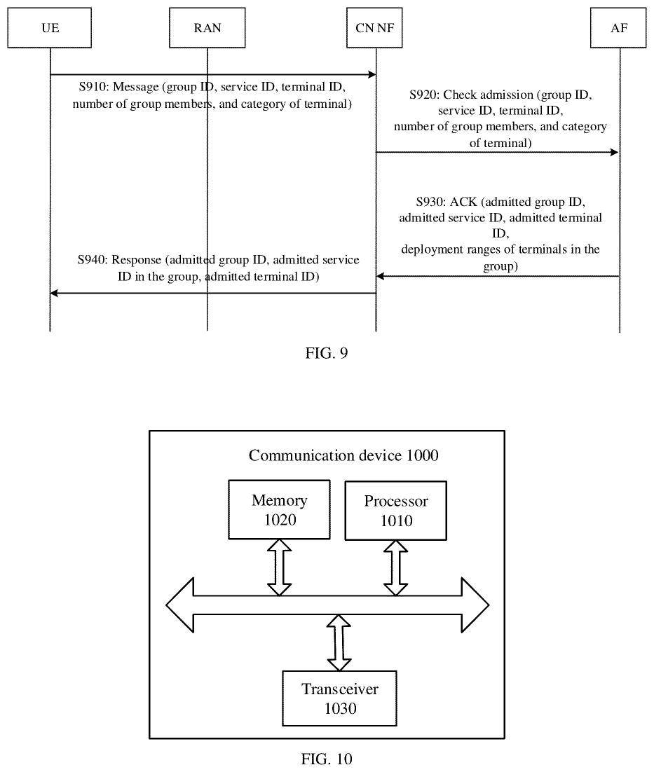

In each service, zero-power consumption terminals may be divided into one or more groups. In each group, a terminal may be selected to request to access the network, such as for network registration, for the other terminals in the group. The registration is not limited to the registration procedure in a 3GPP procedure, but may also represent that the terminal notifies the network that it needs to access the network to obtain services. The identity of the terminal may be preconfigured in the terminal. Alternatively, each terminal may perform registration by itself. As shown in FIG. 9, a procedure of accessing the network may include the following steps.

In S910, when the terminal needs to access the network, the terminal transmits a message to a core network element. For example, the terminal transparently transmits a NAS message to the core network via the base station. Scenarios that require network access include at least one of the following:
1. in a case that a service demand is generated within the terminal;
2. in a case that the terminal has received a trigger signal which may come from at least one of the following:
a. periodic transmission by the base station; For example, the terminal transmits a message to the base station by using a scatter signal.
b. a scanning device passed by; For example, the scanning device transmits a trigger signal to the terminal, or supplies power.
c. a time point preset by the terminal;
d. being triggered manually.

The message transmitted by the terminal to the base station may include at least one of the following information: a service ID, a group ID, a terminal ID, ID(s) of group member(s), a number of group members, a category of the terminal, or a deployment range (location range) of a terminal in the group. All IDs here may be IDs newly defined and dedicated to zero-power communication. In addition, the service ID may be an application ID or an ID defined by an operator. The group ID may be a globally unique ID, a group ID within a service, or an ID unique in a PLMN. The terminal ID may be an RFID or an ID defined by the operator. The category of the terminal may be a category of zero-power consumption terminal, a category of group head terminal, or a category of other terminal in the group, e.g., denoted as Category 1, Category 2, Category 3, respectively.

In S920, the core network element may forward the received information to an external application network element, and may further transmit the location information of the terminal to the application network element, and the external application network element may check the received information. The location information of the terminal may be reported by the base station to the core network element, or may be obtained by the core network element itself through other means. In addition, the core network element may obtain the information to be checked from the application network element in advance, and the core network element checks the information received from the base station.

The application network element checks whether the location of the terminal is within the service area corresponding to the received service ID, and may further check whether the deployment ranges (location ranges) of the terminals in the group is within the service area corresponding to the received service ID, for example, may check whether the group ID, terminal ID, IDs and number of group members are consistent with the IDs and number of group members corresponding to the received service ID and/or group ID.

In S930, the application network element returns an admitted service ID and the corresponding service area, an admitted group ID, an admitted terminal ID, and IDs and numbers of group members. For example, the application network element transmits an acknowledgment (ACK) message to the core network element, which includes an admitted group ID, an admitted terminal ID, an admitted service ID, and a corresponding service area.

In S940, the core network element considers that the received group ID, terminal ID, and group members are allowed to access and that they have been registered in the network, and service transmissions may be performed for these terminals in the group. It may be possible that the core network element only allows some terminals in the group to access according to the current load situation.

The core network element notifies the terminal of admission information via the base station, which includes an admitted service ID and a corresponding service area, an admitted group ID, an admitted terminal ID, ID(s) and number of admitted group member(s).

After receiving the admission information, the terminal may determine whether the network is allowed to access according to the admission information, and notify the group members allowed by an application, or notify other terminals in the group via a PC5 interface.

The group registration used may reduce overall signaling exchanges and reduce complexity.

FIG. 10 is a schematic block diagram of a communication device 1000 according to an embodiment of the present application. The communication device 1000 includes a processor 1010. The processor 1010 is capable of calling and running a computer program from a memory to cause the communication device 1000 to implement the methods in the embodiments of the present application.

In an implementation, the communication device 1000 may further include a memory 1020. The processor 1010 may call and run a computer program from the memory 1020 to cause the communication device 1000 to implement the methods in the embodiments of the present application.

The memory 1020 may be a separate component independent of the processor 1010, or may be integrated in the processor 1010.

In an implementation, the communication device 1000 may further include a transceiver 1030, and the processor 1010 may control the transceiver 1030 to communicate with another device, specifically, to transmit information or data to another device, or to receive information or data transmitted by another device.

The transceiver 1030 may include a transmitter and a receiver. The transceiver 1030 may further include antenna(s), and the number of antenna(s) may be one or more.

In an implementation, the communication device 1000 may be the first device in the embodiments of the present application, and the communication device 1000 may implement the corresponding processes implemented by the first device in various methods in the embodiments of the present application, which will not be repeated here for brevity.

In an implementation, the communication device 1000 may be the second device in the embodiments of the present application, and the communication device 1000 may implement the corresponding processes implemented by the second device in various methods of the embodiments of the present application, which will not be repeated here for brevity.

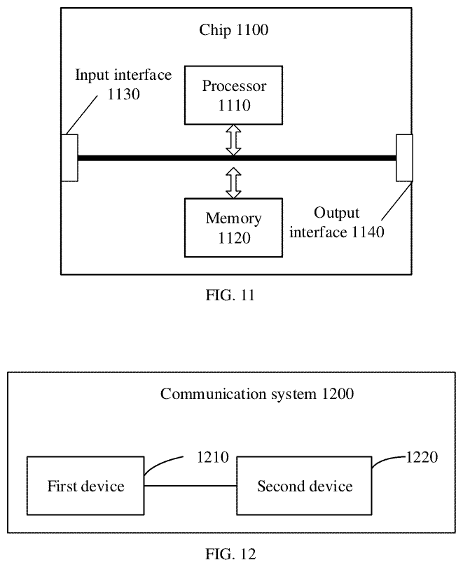

FIG. 11 is a schematic block diagram of a chip 1100 according to an embodiment of the present application. The chip 1100 includes a processor 1110, which is capable of calling and running a computer program from a memory to implement the methods in the embodiments of the present application.

In an implementation, the chip 1100 may further include a memory 1120. The processor 1110 may call and run a computer program from the memory 1120 to implement the method performed by the first device or the second device in the embodiments of the present application.

The memory 1120 may be a separate component independent of the processor 1110, or may be integrated in the processor 1110.

In an implementation, the chip 1100 may further include an input interface 1130. The processor 1110 may control the input interface 1130 so as to communicate with another device or chip, and specifically, may obtain information or data transmitted by another device or chip.

In an implementation, the chip 1100 may further include an output interface 1140. The processor 1110 may control the output interface 1140 so as to communicate with another device or chip, and specifically, may output information or data to another device or chip.

In an implementation, the chip may be applied to the first device in the embodiments of the present application, and the chip may implement the corresponding processes implemented by the first device in various methods of the embodiments of the present application, which will not be repeated here for brevity.

In an implementation, the chip may be applied to the second device in the embodiments of the present application, and the chip may implement the corresponding processes implemented by the second device in various methods of the embodiments of the present application, which will not be repeated here for brevity.

The chip applied to the first device and the chip applied to the second device may be the same chip or different chips.

It should be understood that the chip mentioned in the embodiments of the present application may also be referred to as a system-level chip, system chip, chip system or system-on-chip chip.

The processor mentioned above can be a general-purpose processor, a digital signal processor (DSP), a field programmable gate array (FPGA), an application specific integrated circuit (ASIC) or other programmable logic devices, transistor logic devices, discrete hardware components, etc. The above-mentioned general processor may be a microprocessor or any conventional processor.

The memory mentioned above may be a volatile memory or a non-volatile memory, or may include both volatile and non-volatile memories. The non-volatile memory may be a read-only memory (ROM), a programmable read-only memory (PROM), an erasable programmable read-only memory (EPROM), or an electrically erasable programmable read-only memory (EEPROM) or a flash memory. Volatile memory may be random access memory (RAM).

It should be understood that the above-mentioned memory is an exemplary but not restrictive description. For example, the memory in the embodiments of this application can also be static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synch link dynamic random access memory (SLDRAM), direct rambus random access memory (DR RAM). In other words, the memory in the embodiments of this application is intended to include, but is not limited to, these and any other suitable types of memories.

FIG. 12 is a schematic block diagram of a communication system 1200 according to an embodiment of the present application. The communication system 1200 includes a first device 1210 and a second device 1220.

The first device 1210 is configured to perform the above-mentioned method 400 for accessing a network.

The second device 1220 is configured to perform the above-mentioned method 500 for accessing a network.

The first device 1210 may be configured to implement the corresponding functions implemented by the first device in the above method 400, and the second device 1220 may be configured to implement the corresponding functions implemented by the second device in the above method 500, which will not be repeated here for brevity.

The above embodiments may be implemented in whole or in part through software, hardware, firmware, or any combination thereof. When the above embodiments are implemented by using a software, the software may be implemented in a form of a computer program product in whole or in part. The computer program product includes one or more computer instructions. When the computer instructions are loaded and executed on a computer, all or some of the processes or functions of the implementations of the present application are performed. The computer may be a general-purpose computer, a special-purpose computer, a computer network, or any other programmable apparatus. The computer instructions can be stored in a non-transitory computer-readable storage medium, or transmitted from one non-transitory computer-readable storage medium to another non-transitory computer-readable storage medium. For example, the computer instructions can be transmitted from one website, computer, server, or data center to another website, computer, server, or data center in a wired manner or in a wireless manner. Examples of the wired manner can be a coaxial cable, an optical fiber, a digital subscriber line (DSL), or the like. The wireless manner can be, for example, infrared, wireless, microwave, or the like. The non-transitory computer-readable storage medium can be any computer accessible usable-medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (SSD)).

It should be understood that in various embodiments of the present application, the sequence numbers of the above-mentioned processes do not mean the order in which they are performed, and the order in which the various processes are performed should be determined by their functions and internal logic, and should not constitute any limitation on the implementing process of the embodiments of the present application.

Those skilled in the art can clearly understand that for the convenience and brevity of the description, specific working processes of a system, an apparatus and a unit described above can refer to the corresponding processes in the foregoing method embodiments, and details will not described here again.

The foregoing descriptions are merely specific implementations of the preset application, but the protection scope of the preset application is not limited thereto. Any person skilled in the art could readily conceive of changes or replacements within the technical scope of the preset application, which shall all be included in the protection scope of the preset application. Therefore, the protection scope of the present application shall be subject to the protection scope of the claims.

What is claimed is:

1. A first device, comprising a processor and a memory, wherein the memory is configured to store a computer program, and the processor is configured to call and run the computer program stored in the memory to cause the first device to perform:
transmitting first information, the first information comprising information of the first device that requests to access a network and/or information of a group to which the first device belongs; and
receiving second information, the second information comprising response information that is determined according to the first information.

2. The device according to claim 1, wherein the first information comprises at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

3. The device according to claim 1, wherein the response information comprises at least one of the following:
information on admission to the network, comprising information of the first device admitted to the network and/or information of the group to which the first device belongs; or
rejection information, comprising a reason for rejecting access to the network.

4. The device according to claim 3, wherein the information on admission to the network comprises at least one of the following:
a service ID allowed for use, a service area corresponding to the service ID allowed for use, an admitted group ID, an admitted ID of the first device, ID(s) of admitted member device(s) in a group, or a number of the admitted member device(s) in the group.

5. The device according to claim 2, wherein the group ID comprises at least one of a globally unique ID, a group ID within a service, or an ID unique in a PLMN.

6. The device according to claim 2, wherein the service ID comprises at least one of an application ID or an ID defined by an operator.

7. The device according to claim 2, wherein a device ID is at least one of a radio frequency identifier (RFID) of a device, an ID defined by an operator, or a network access identifier (NAI).

8. The device according to claim 2, wherein a category of a device comprises at least one of a zero-power consumption terminal, a group head terminal, or other non-group head terminal in a group.

9. The device according to claim 1, wherein a condition for the first device to transmit the first information comprises at least one of the following:
the first device generating a service demand;
the first device having received a trigger signal;
the first device reaching at a preset time point; or
the first device being manually triggered.

10. The device according to claim 9, wherein the trigger signal comprises at least one of the following:
scatter signals periodically transmitted by an access network device;
a trigger signal transmitted by a scanning device; or
a function signal transmitted by the scanning device.

11. The device according to claim 1, further configured to perform:
transmitting a notification of admission to the network to terminal(s) admitted to the network in the group or other terminal(s) in the group in a case of determining that the network is allowed to access according to the information on admission to the network.

12. A second device, comprising a processor and a memory, wherein the memory is configured to store a computer program, and the processor is configured to call and run the computer program stored in the memory to cause the second device to perform:
receiving first information, the first information comprising information of a first device that requests to access a network and/or information of a group to which the first device belongs;
obtaining second information, the second information comprising response information that is determined according to the first information; and
transmitting the second information.

13. The device according to claim 12, wherein the first information comprises at least one of the following:
a group identity (ID) of the first device, an ID of a member device in the group to which the first device belongs, a number of member devices in the group to which the first device belongs, a location range of a member device in the group to which the first device belongs, a service ID requested to be used, an ID of the first device, a category of the first device, or a category of a member device in the group to which the first device belongs.

14. The device according to claim 12, wherein the second device is an access network device; and receiving the first information comprises: receiving the first information from the first device.

15. The device according to claim 14, wherein obtaining the second information comprises:
transmitting the first information to a core network device; and receiving the second information from the core network device.

16. The device according to claim 12, wherein the second device is a core network device; and receiving the first information comprises: receiving the first information of the first device via an access network device.

17. The device according to claim 16, wherein obtaining the second information comprises at least one of the following:
determining the second information according to the first information; or
transmitting the first information to an application device; and receiving the second information determined by the application device according to the first information.

18. The device according to claim 12, wherein the second device is an application device; and receiving the first information comprises: receiving the first information of the first device via a core network device and an access network device.

19. The device according to claim 18, wherein transmitting the second information comprises:
transmitting the second information to the first device via the core network device and the access network device.

20. The device according to claim 17, wherein a way of determining the second information comprises at least one of the following:
checking whether a location range of the first device is within a service area corresponding to a received service ID;
checking whether a location range of a member device in the group to which the first device belongs is within a service area corresponding to a received service ID; or
checking whether at least one of a received service ID, a received group ID, a received ID of the first device, a received ID of a group member, or a number of group members received is consistent with known information of the second device.
